(19) United States
(12) Patent Application Publication
(10) Pub. No.: US 2004/0260569 A1
(43) Pub. Date: Dec. 23, 2004

(54) Expert legal task management

(75) Inventors: Kevin M. Bell, Sterling, VA (US); Marc R. Labgold, Great Falls, VA (US)

Correspondence Address: PATTON BOGGS LLP, 8484 WESTPARK DRIVE, SUITE 900, MCLEAN, VA, 22102, US

(73) Assignee: Cyber Legal Solutions, Inc., Vienna, VA

(21) Appl. No.: 10/717,505

(22) Filed: Nov. 21, 2003

Related U.S. Application Data
(63) Continuation of application No. 09/657,226, filed on Sep. 7, 2000, now abandoned.

(51) Int. Cl. G06F 17/60

(52) U.S. Cl. 705/1

(57) ABSTRACT

A method of managing a complex task is organized around a central outline, which starts with all of the possible subtasks and which is pared to remove non-relevant subtasks. The paring occurs during an initial profiling of the task. Further paring occurs manually. Other tools, such as automated document production and data warehousing, are integrated.

### BACKGROUND OF THE INVENTION

1. Field of the Invention

The invention relates generally to a system and method for managing complex legal tasks and more specifically to an environment for a complex legal task which guides the user through the task by providing logic trees based upon expert legal analysis and content in addition to performing information management and providing document management and production functions.

2. Discussion of the Background

Many legal tasks, though based upon an established knowledge base, are complex and therefore difficult to manage in practice. Many such tasks are repetitive in nature, involving the same or similar analyses being performed in multiple instances, by multiple individuals, with the overall goal of providing a consistent work product based upon sound established principles. An example of such a complex legal task is litigation in general and patent litigation in particular. Another such example is the due diligence analysis which is typically required for such complex transactions as mergers, acquisitions, initial public offerings and other securities-related transactions, franchising and the like. The current invention provides a system and method for managing any type of complex legal task, but is believed to be particularly useful for intellectual property applications in general and litigation tasks in particular. The instant invention is particularly useful for complex litigation such as patent, antitrust and securities litigation where large volumes of information, documents and complex legal principles must be coordinated and managed efficiently and effectively. Accordingly, the invention will be discussed primarily in connection with patent litigation task management. It will be readily understood, however, that the invention may be applied to wide variety of legal tasks, including tasks in fields apart from intellectual property.

In modern litigation practice, an attorney faces two different yet interrelated challenges. First, the attorney must develop and implement the strategy for the conduct of the litigation. Second, the attorney must manage the information received in the litigation and integrate the same into the overall litigation strategy. Developing an effective litigation strategy involves identifying causes of action, defenses, and counterclaims. For example, in a patent litigation, a plaintiff may be able to assert interrelated causes of action such as infringement and inducement to infringe a patent, and seek multiple forms of relief such as monetary relief, injunctive relief, declaratory relief, or any combination of the above. Likewise, there may be grounds for non-infringement, invalidity, unenforceability, laches, intervening rights or other types of defenses available to the defendant. These defenses are each predicated upon their own separate, yet often interrelated, factual underpinnings. For example, an invalidity defense may be based upon a patent or printed publication, an on-sale issue, etc. An unenforceability defense may be. based on inequitable conduct by the patentee before the U.S. Patent and Trademark office in failing to disclose a patent, printed publication or on-sale issue to the examiner. The foregoing validity and unenforceability defenses can, under certain circumstances, depend upon the same basic facts and circumstances or, alternatively, may be wholly independent of each other. The recognition of possible causes of action, defenses and counterclaims, as well as their relationships, overlap, interference and/or impact with the others is of great importance in the effective conduct of a litigation. Being able to effectively manage the facts, documents and other information obtained through, for example, the discovery process, is of critical importance to the effective conduct of the litigation.

The task of managing the information in a complex litigation such as a patent litigation is by itself a difficult task. Literally thousands of documents may be encountered by an attorney during a complex litigation. These documents include documents produced by the opposing side in response to document requests, documents produced by the client, deposition transcripts, attorney-generated memos and other work product, expert reports, etc. Some of these documents may ultimately prove useless, some may be relevant to a single issue and some may be relevant to multiple issues. The documents may be needed at different points in the litigation. For example, a single document may be required at a hearing for a preliminary injunction, in a deposition, in a summary judgment motion, and at trial. These documents must be tracked as well as associated in some way with the issues to which the documents are relevant. Additionally, documents which can be characterized as useless, may at a later time become relevant as new issues arise and their relevance is appreciated. Thus, the ability to catalog and maintain what is initially indicated to be useless information is also important.

While various software programs designed to aid attorneys in managing litigation exist today, such programs are significantly limited to organizing and accessing information input by the user. More significantly, none of the currently available software programs or document management systems provide expert logic based analysis to guide the user in developing an effective strategy or in determining whether the available information (such as that obtained through discovery) is applicable to the issues present in the case at hand.

One type of such software can be described as document management programs. An example of such a program is Summation®. Such programs create databases for the documents in a case. The database typically holds entries such as document author, recipient, date, subject, etc., for each document. Production numbers (such as Bates numbers) are typically used as the individual document identifiers. The database may then be searched using fixed criteria to retrieve documents of interest. For example, a search for all documents written by John Smith concerning the Acme Contract issue between Jun. 1, 1980 and Sep. 1, 1990 could be performed. The results of the search would list the production numbers (or other indices or identifiers) of the corresponding documents and/or other discovery related materials (i.e., deposition testimony). The documents themselves may be imaged and stored on the computer, so that a document image may be retrieved by selecting a production number returned in the search results. While tools such as these are useful, they only address a small subset of the tasks which must be performed by an attorney.

Another type of program currently available can be referred to as case outlining programs. An example of such a program is CaseMap®. This program allows an attorney to enter facts, issues, objects and questions. The program then allows attorneys to create links between these various categories. For example, a link can be created between a fact (“the car was blue”) and an object (a deposition transcript in which the deponent states that she saw a blue car). This program provides a spreadsheet-based format which allows an attorney to create a case outline to organize data entered by the attorney.

A serious shortcoming of the currently available programs is that they require the attorney to provide all of the information for the outline. However, these programs provide the attorney with no input or assistance in developing the strategy for the litigation or in determining whether or not a link created between a given document and a given issue is valid under the applicable law or objective (and often subjective) criteria.

The shortcomings described above in connection with known litigation tools are common to management software in a wide variety of fields. What is needed is a more useful tool that addresses most, if not all, of these shortcomings and provides, in a single program/system, the resources needed to manage a complex task.

### SUMMARY OF THE INVENTION

The present invention addresses and meets the aforementioned needs by providing a method and apparatus in the form of a computer and associated content-based software for managing a complex legal task such as litigation. The invention organizes the task around a body of content which can be represented as a central outline that is prepared beforehand by an expert and contains all of the subtasks that may comprise the task to be performed. The term “outline” in the context of this invention is not intended to be a list which is outline skeletal in format. Instead it contains detailed information and expert content concerning the issues presented. This outline is generic to a particular legal task (i.e., for any particular task, the outline contains every likely issue/scenario). At the outset of the process, a series of questions are presented to the user. Based on the user's answers, the content-based software system pares down the outline to eliminate those portions that are not relevant to the task at hand. The outline may also be manually edited with an outline viewer tool to deactivate portions of the outline that are no longer relevant or reactivate inactive portions if new information becomes available. The outline may also be enlarged to handle unusual situations (such as unique fact scenarios) that are not contemplated by the outline, although these situations are expected to be rare. This outline paring method should be contrasted with known task management software, where the information for the outline is provided wholly or mostly by the user. The outline paring method helps to ensure that subtasks are not inadvertently overlooked. This provides the additional benefit of expert input in the selection and paring process. By doing so, the instant invention ensures that all possible options can be raised and then accepted or eliminated only afer full consideration by the qualified user.

The invention also provides a number of other tools to the user. A workroom function is provided which includes an image viewer that allows the user to view documents associated with the task and associate these documents with corresponding outline sections (i.e., issues). A calendar function is provided to manage dates associated with the task. Some of the information entered during the task interview process will be inputted directly into the calendar. A contact database is provided to keep a record of names and addresses associated with the task. Here again, some information entered during the task interview process will be inputted directly into the contact database (i.e., contact information of parties, counsel, court, etc . . . ). Reference tool functionalities are provided to allow the user to access reference materials that may be needed for the task. A document generator produces documents, or work product, which are based on the outline and may include additional expert information. Other tools that are task specific may also be provided. For example, a trial notebook tool is provided for litigation task management embodiments of the invention. This tool allows the user to prepare and organize the information and documents which are still active in the litigation at the time of trial. Similarly, a due diligence notebook tool is provided for due diligence related task management embodiments of the invention such as mergers, acquisition, franchise, securities-related transactions and the like.

### BRIEF DESCRIPTION OF THE DRAWINGS

A more complete appreciation of the invention and many of the attendant features and advantages thereof will be readily obtained as the same become better understood by reference to the following detailed description when considered in connection with the accompanying drawings, wherein:

FIG. 1 is a block diagram showing the interconnection of various components of a patent litigation task manager according to a first embodiment of the present invention.

FIG. 2 is a block diagram showing the functional modules of the task manager of FIG. 1.

FIG. 3 is a diagram showing the main menu of the task manager of FIG. 1.

FIG. 4 is a diagram showing the case menu window of the task manager of FIG. 1.

FIG. 5 is a diagram of the workroom menu window of the task manager of FIG. 1.

FIG. 6 is a diagram of the document manager window of the task manager of FIG. 1.

FIG. 7 is a diagram of the issue window of the task manager of FIG. 1.

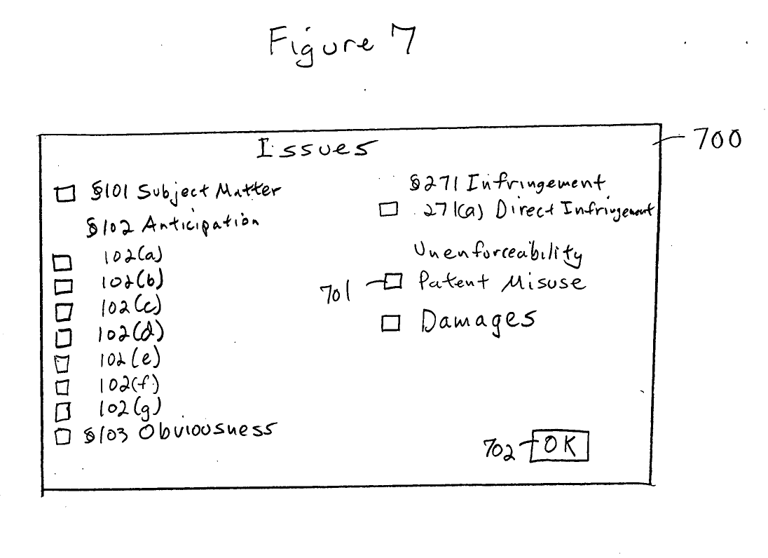

FIG. 8 is a diagram of the deposition transcript manager window of the task manager of FIG. 1.

FIG. 9 is a patent genealogy diagram according to an embodiment of the present invention.

### DETAILED DESCRIPTION OF THE PREFERRED EMBODIMENTS

The present invention will be discussed with reference to preferred embodiments of complex task manager computer programs. Specific details, such as types of documents, specific outline sections, depth of the outline, etc., are set forth in order to provide a thorough understanding of the present invention. The preferred embodiments discussed herein should not be understood to limit the invention.

The present invention provides a method and apparatus in the form of a computer and associated content-based software for managing a complex task. The invention organizes the task around a central outline which is prepared beforehand by an expert and contains all of the subtasks that may comprise the task to be performed. This outline is generic to a particular task (i.e., for any particular task, the outline contains every likely issue/scenario). As more information about the task becomes known, the outline is pared down to eliminate those portions that are not relevant to the task at hand. The outline may also be enlarged to handle unusual situations that are not contemplated by the outline, although these situations are rare, or when an issue not previously applicable under the given facts of the case becomes relevant through the discovery of new information or other change in circumstances. This outline paring method should be contrasted with known task management software, where the information for the outline is provided wholly or mostly by the user. The outline paring method helps to ensure that subtasks are not inadvertently overlooked. This provides the benefit of expert input in the selection and paring process. By doing so, the instant invention ensures that all possible issues can be raised, options assessed and then accepted or eliminated only afer full consideration by the qualified user.

For example, in the case of a patent litigation, the invention ensures that the proper standard of care is provided by raising each and every possible cause of action (on behalf of the plaintiff/patent holder) or each defense/counterclaim (on behalf of the defendant/accused infringer). The invention allows, and causes, the user to weigh and consider the applicability of each possible cause of action and/or defense/counterclaim, with elimination of the issue being possible only after full consideration of the relevant information and applicable law by the attorney. In this regard, it is expected that the instant invention will reduce the risk of liability often faced by attorneys (or other professionals) who overlook the availability or applicability of (or fail to appreciate) a given course of action.

The first component of the invention is the task profiler, which is an interactive question and answer routine in which the basic facts about a task are entered in response to expert queries. The task profiler aids in the importation of useful data into the software environment and assists the user in identifying the relevant or applicable issues based upon the expert content. For example, in the context of a litigation task, the names of the parties, all counsel, venue, court contact numbers, jurisdictional grounds, etc., will be gathered in this step. Similarly, in the context of a due diligence tasks, information concerning the form and location of corporate entities can be ascertained and input. Information input via the task profiler is maintained for multiple purposes including generating a contact database, generation of pleadings, and other uses as described in greater detail below.

After such basic information has been entered, a series of questions is then asked for the purposes of identifying and “activating” the issues to be pursued in the context of the task. Each outline subtask may have one or more questions associated with it. For example, in a patent litigation context, where previous answers to logic-based questions indicate for example, aa pa the existence (or potential existence) of prior art, a logic-based sub-questionnaire is provided to aid in the determination of whether the prior art reference is an anticipatory reference under 35 U.S.C. § 102 or, alternatively, that it lacks a given element and therefore must be combined with another teaching under 35 U.S.C. § 103. If the reference is deemed § 102 prior art, the user is then provided yet another logic-based subroutine which aids in determining which subsections of § 102 are applicable. If the reference is deemed potential § 103 prior art, the program guides the user through a logic-based subroutine to determine if, in fact, there is evidence which, for example, teaches the missing elements as well as evidence that one of ordinary skill in the art would be motivated to combine the available teachings to arrive at the claimed subject matter. Each of the questions presented is designed to eliminate a “branch” of the provided expert content outline and to raise the user's awareness of the applicability and requirements of a given issue. If, in the foregoing example, the answer to the question “does the reference teach (either explicitly or inherently) each and every element of the claim at issue?” is negative, then the issue of anticipation is eliminated (i.e., pared) from the litigation outline function. The user would then be prompted by questions such as “are the elements of the claimed subject matter which are not found in the reference taught by a second reference or otherwise known to one of ordinary skill in the relevant art?” If the answer to the questions is positive or not known at the present time (as might be the case at the outset of a given case where it is too early to know which claims are asserted or what date of invention will be asserted, or where the prior art has yet to be searched), that branch of the outline is left active for future consideration as the relevant information becomes available or known.

An important aspect of the invention is the value in the outline paring approach. The provision of expert content in the form of an outline, rather than relying on the user to provide the information in the outline, represents a new paradigm in complex task management software. By posing a number of questions to a user based on a complete outline, the user will be forced to consider issues which might not have occurred to her. This feature is crucial as it facilitates effective use of the system by non-expert, as well as expert, users. For example, in a patent litigation task management context, an attorney (such as a non-patent in-house corporate general counsel) may have forgotten or may not be familiar with an equitable estoppel defense. By asking questions (driven by the outline) about all possible issues which can possibly be raised under a certain set of circumstances, the user is forced to at least consider the issues. While it must be recognized that this approach is not foolproof, as the user can make the wrong decision and improperly pare the outline by answering the questions in the negative or by manually removing the issues from the outline, the approach provided by the instant invention will at least ensure that the user considers the issue before it is discarded. The other information provided in the context of the content-based software environment, such as explanatory notes and available treatises and/or digests, aids the user in the proper analysis of the given facts and thereby decreases the risk of eliminating a viable option. Thus, the instant invention provides the expert analysis to guide the user through the logic-based analysis of the given task at hand. That such an analysis is required is not only of interest to the attorney, but also of critical interest to the client and liability carriers. The instant invention is intended to reduce negligence caused by inexperience, unfamiliarity with the given task, and/or inadvertent oversight while also assisting in the overall management of the complex task.

Once the task profiler functions have been completed, the user has access to an outline viewer in which the pared expert task outline may be reviewed and printed if desired. It should also be noted that since the outline method of the instant invention relies on the novel techniques of paring down from an existing expert-prepared outline, the expert outline in its entirety can also be printed at any time. Also, the user is allowed to manually pare the outline. The outline is maintained in a textual form, preferably formatted for commonly used word processor programs such as Microsoft Word® or Corel WordPerfect®. In a litigation context, the program allows the user to generate a litigation outline at any time with the ease of selecting the print option. The outline can be viewed in complete content-based format or in a preferred embodiment viewed only in the pared format. The outline can be viewed or printed in a variety of formats depending on the end-user (i.e., the litigation staff, the client, etc). The end-user will be able to select from a menu of viewing choices such as “by statute”, “by patent”, etc. By selecting a viewing preference, the outline will be automatically reformatted pursuant to the user's preference. The user will also be able to select a separate tab which will allow customization of the outline. This allows the user to only include those sections of the outline which the user wishes to view/print. The ability to add sections to the outline in the event that the expert-prepared outline either is missing a section due to a unique set of facts, or more likely, where a section has been prematurely or incorrectly removed, may optionally be provided. The user may be provided with the option of viewing the outline with the pared sections grayed-out or with the pared sections completely invisible. The user may also be provided with the option to reactivate mistakenly pared outline sections.

In addition to the above actions, the user may modify the outline by adding task or sub-task particulars to it. For example, in a patent litigation application, the outline will have sections for a 35 U.S.C. § 102(b) prior art publication defense. The task profiler will have asked the user to identify such a document (see discussion below of document image viewing and issue assignment) and will have already linked the document to the outline (i.e., created an electronic flag as discussed below). The user may then modify the outline in the outline viewer by adding sections for the particular patent and claims that are anticipated by the publication. Still further, the user may create subsections for each element of the claim. By doing so, the user may instantly print a claim chart comparing the elements of the claim to the reference citations. The claim chart function allows the user to prepare claim charts in a variety of formats which may be modified or customized to suit the end-users' needs.

Several other tools are available in addition to the outline viewer. One such tool is the fixed database viewer. In the context of the present invention, a fixed database is a reference body of knowledge that is not changeable by the user (the fixed database can, however, be updated from time to time as necessary). Examples of fixed databases include references such as textbooks (e.g., Chisum on Patents in a patent litigation application), dictionaries (general or specialized), etc. Other references particular to a task may also be included. Examples of this are case law digests, legal statutes, the Federal Rules of Civil Procedure, the Manual of Patent Examining Procedure, etc. Having such information available within the software application itself will be of immense value to users as it will allow them to work on the task in a complete working virtual environment contained on a laptop or desktop computer and completely independent of, and without the need to rely upon, a bricks-and-mortar office.

The foregoing “fixed databases” are fully updatable and upgradeable, thereby ensuring that the expert task manager system is current and takes into account changes in circumstances such as a change in common and/or statutory law. As discussed below, in a preferred embodiment such updates/upgrades are accomplished via an internet hosted server function.

Another tool is the contact database. Many tasks will involve the names and addresses of various people associated with the task. For example, in a litigation application, the names, addresses and telephone numbers of opposing counsel, local counsel, the judge, the client, experts, etc. will be required from time to time, whether for inclusion in a document or other purposes. The contact database maintains these in a searchable database. This information can be accessed by other tools in the program as will be discussed further below. Additionally, this information is formatted and maintained in such a fashion as to allow for the synchronization between the users computer and a PDA device such as a Palm OS® device, Windows CE® device or the like.

The subject invention also may include a calendar tool. This tool is useful for storing, managing and tracking dates such as due dates and hearing dates (i.e., docket entries) in a litigation application. In the context of a litigation application, the invention provides for the electronic docketing of relevant information. In the context of the patent litigation embodiment, critical dates are automatically provided to ensure against inadvertent oversight. An example of such a date is that required under 35 U.S.C. § 282. The program will automatically provide a reminder at a date (e.g., thirty days) in advance of the trial date entered into the calendar function. The reminder will provide not only the date, but also a cross-reference to the statutory and other information required to explain the significance of the § 282 prior art disclosure. The software may optionally generate a draft § 282 notice based upon the information contained in the litigation outline. The software will again provide the prompt at the actual due date of the notice (i.e., 30 days in advance of trial in the case of a § 282 prior art disclosure). Thus, the instant invention provides not only expert analysis in the substantive areas, but also in the procedural aspects of the case. As with the contact database, this information is formatted and maintained in such a fashion as to allow for the synchronization between the user's computer and a PDA device.

In a preferred embodiment, the calendar function may also be “pre-loaded” with the dates required under a particular court's local rules. For example, the United States District Court for the Northern District of California has implemented specialized local rules for patent litigation (See, Local Rules for the United States District Court for the Northern District of California, Rules 16-6-16-11). These rules include court imposed dates for such events as Initial Disclosure of Asserted Claims (L.R. 16-7(a)), Initial Disclosure of Prior Art (L.R. 167(d)), dates for filings relevant to claim construction (L.R. 16-10 and 16-11), and the like. The rules generally impose the timing for filings or responses thereto in terms of days (i.e., no later than 45 days after the filing of the complaint). The instant invention provides the option of allowing the calendar function to implement these rules, providing the proper calculation of the various requirements thereunder and providing the necessary prompts in advance of the required due dates.

Another aspect of the instant invention is the workroom function and associated tools. The workroom is a component of the instant invention which stores “data items” and facilitates their organization and use within the remaining functionalities of the subject invention. As used herein, the term “data items” refers to database-coded information, text files, either directly imported or created through the use of optical character recognition (“OCR”), image files which can be in any of the commonly recognized formats, video files, audio files, or any other form of information and format. For example, in a patent litigation application, numerous documents are exchanged between the parties during the discovery process. The documents are preferably imaged into a standard image format (such as TIFF), coded by numerous database fields (i.e., author, recipient, date, title, document number, etc.) and subjected to OCR. By OCRing the imaged documents, they become full-text searchable. The OCR text file is then electronically linked, much like a relational database, thereby interconnecting the information contained in (1) the coded fields (2) the OCR text files and (3) the image files. Thus, a multitude of searches are possible. For example, a search could be performed to locate all documents authored by John Smith. This search would be run through the database field designated for the “author” field. A list of results would be generated which listed all documents in which John Smith had been identified as the author in the relevant database field. The user would then have the ability to select individual documents which are linked to the related image file. The result would be the retrieval of the related image filed presented in an image viewer.

Alternatively, a search can be performed on the full OCR text file associated with a particular image file or set of image files. For example, one can search the term “John Smith” through the OCR text file and generate a list of all documents in which John Smith appeared anywhere in the text. This is contrary to the coded field search which would limit search results to those documents or data items where John Smith was the actual author.

The search results can be displayed in any user-defined format. In a preferred embodiment, the listing contains an icon on the document and such descriptions as document title, date, author, recipient, etc., the display of which is optional and can be customized by the user. The user would then have the ability to select individual documents which are linked to the related image file. The result would be the retrieval of the related image file presented in an image viewer.

An additional feature of the workroom will be the ability to electronically file documents retrieved through search results. For example, a search can be run which will return a list of data items that satisfy the user's search criteria. These documents can then be filed electronically. Thus, if the user was preparing a file of all documents authored by John Smith, the search would be run through the author field for John Smith. The relevant data items received be returned in the search result list. These documents could then be electronically filed by a group to maintain a separate sub-category of documents. This feature is very helpful in organizing documents for depositions, witness preparation, etc.

Another way information is linked can be found in the workroom's transcript manager. Currently, when taking depositions, an ASCII text file (or other text format file) is created. This file is a written transcription of an oral deposition. In accordance with the subject invention, such text files can be imported and are full-text searchable. A user has the ability to run a word or phrase search, whether by using boolean logic or “fuzzy” logic or other statistical ranking search queries, to retrieve a list of “hits” or results in all places that the desired word or phase is located. The user is then able to quickly view the areas in the transcript where the desired word or phrase was found. Additionally, the exhibits marked at a deposition can be scanned into a standard image format and imported and linked to the places in the transcript each exhibit was marked, thereby allowing the user to easily select an exhibit for viewing while reviewing the transcript. The selection of an exhibit would retrieve the related imaged exhibit and present it in an image viewer.

The image viewer will allow the user a great deal of functionality through the use of mark-up and annotation tools and note files found in pull-down menus or toolbars. Such annotations will include at least highlighting, redacting, drawing lines, circles, arrows, rectangles, polygons, polylines, ellipses and freehand in numerous colors, rotating images, viewing images in a tiling, cascading or thumbnail arrangement, reducing, enlarging and copying images or portions thereof, moving images within viewer, and creating and saving note files. Any annotations the user wishes to save are normally stored in a file separate from and linked to the original image file. Thus, the integrity of the original image file remains intact. The image viewer will also be able to view multimedia and animation files.

An additional feature will be the ability to view multimedia files, such as digitized video depositions transcripts or animations. In a preferred embodiment, these files will be synchronized with audio and text files so the user can listen to and view the digitized deposition while also viewing the text of the transcript as it scrolls next to the video/multimedia file. Such deposition viewing technology is employed in several commercial products including inData Corporation's Deposition Director™ product. Smaller clips or segments may be created and edited from these files to create short outtakes from the deposition to be viewed individually. As in the description outlined above, the user will be able to search the imported text file by word or phrase and then select a result which is linked to the audio and video files. Therefore, if the user clicks on a portion of text, the audio and video files will be launched or opened at that portion of the file selected. As also identified above, the exhibits or documents can be linked in the text such that selecting it will launch an additional window in which the exhibit/document can be viewed. In the preferred embodiment, the user has the ability to view the deposition and listen to the testimony while also having the ability to view the text of the transcript and the exhibits marked at the deposition.

Yet another workroom feature is the ability to file and organize documents, images, search results and files electronically. This will allow the user to create storage areas for information which the user wants to organize in a specific fashion. This will provide the user with the ability to take either the results of search queries or specific items and selectively place them in files for purposes of storage, organization and subsequent access. In a patent litigation case, this is helpful in the organization of documents relating to specific issues or witnesses. The selection and storage of related information increases makes organization and review of related materials easier and increases efficiency over many traditional document management features. Additionally, documents can be selected and stored though the use of a pop-up window as discussed below.

The workroom preferably allows the user to annotate the documents as well. For example, a document in a patent litigation may be important to an inequitable conduct defense. The workroom allows an attorney reviewing the document to so annotate the document with a note file outlining particular comments by the attorney. Marking a document for privilege is another way in which the annotation function may be used. By marking a document privilege, however, you restrict the ability to print this document. This is done in order to avoid the inadvertent production of material properly protected by an applicable privilege. The user may also mark a document as reviewed. This allows the user, or multiple users, to avoid duplicative document review. In addition, the workroom preferably allows all document to be identified with a unique identifier number and code when a party's own documents are scanned into the database. The workroom tool may also provide an option to assign a unique production number which is electronically associated with and printed on the document itself. This form of an “electronic Bates number” aids in both document production and in work reduction and is an improvement over traditional manual methods of bates numbering. Additional information which can be electronically offered includes electronically affixing confidential stamps, bar codes, etc., to the imaged documents.

Another novel aspect of the invention is the means by which imaged documents are indexed and catalogued into the expert outline. Once scanned, documents are viewed using a document viewer such as that provided by the Document Director™ product manufactured by inData Corporation of Gilbert, Ariz. This type of functionality allows for the facile viewing of the imaged documents with the benefits of an organizational structure tree format which allows for easy cross-referencing and Windows®-like drop and drag functionality. In accordance with the present invention, the foregoing image viewing-type software is modified to include a pop-up sub-screen which contains “issue boxes” corresponding to each of the issues present in the expert task outline section of the program. For example, in the context of the patent litigation embodiment, the pop-up box would have a checkbox for each category in the outline. In the context of a patent litigation program, the categories issues could include, for example, § 101, §102, § 103, etc. Each of these categories is referred to herein as an “issue box” for explanatory purposes only but will be recognized by those skilled in the art as being suitable for use with items other than “issues.” In the case of the due diligence embodiment, the screen would include each aspect of the diligence package such as broad categories as “Corporate Documents”, “Tangible Assets” and “Contracts” with corresponding sub categories such as bylaws, stock ledgers, real property, etc.

The pop-up screen is electronically tied to both the outline function and the image being viewed. By checking the box corresponding to a given issue (i.e., [symbol] § 101) an electronic flag is created, creating a link between the document being viewed and the relevant outline section. In accordance with the instant invention, each image may be linked to as many different issues as are present in the task outline or, alternatively, may be disregarded entirely. In addition to the “issues boxes”, the pop-up screen may also contain other classifiers such as “work-product”, “attorney-client privilege” or the like. Such classifiers may also be programmed to create restrictions, such as in the case of privilege, barring access to such documents unless permissive access is granted by a system administration code. Additionally, user-defined “issue boxes” can be created such as “hot docs” or other personal identifier such as attorney name or the like. It will be recognized by those of skill in the art that other modifications can be similarly employed to customize the document/issue linking function to suit any particular need or application.

In a preferred embodiment, the “issue box” pop-up screen contains all of the issues in the entire outline, however, those issues which have been pared out of the original expert outline (i.e., because the issue is not relevant to the case as profiled) appear in a grayed-out or muted format. This provides for easy visual recognition of the active issues, while allowing the user to still view the other inactive options. Should one of the inactive options become viable (i.e., a given document supports a new issue) the program provides for reactivation and integration into the working case outline. In such circumstances, should the inactive box be checked, a prompt is provided informing the user that the selected issue is not active and asking the user if they wish to reactivate the issue and create a corresponding section in the litigation outline. If the response is yes, the program automatically reactivates the issue within the case outline, activating all relevant sub-parts as well. It should be recognized that while this reactivation function has been described in the context of the grayed-out, delimited pop-up screen, the same functionality is fully applicable within any of the pop-up screen viewing options.

In another preferred embodiment, the “issue box” pop-up screen is further presented in such a manner that only those issues that are active in the case outline are viewable within the pop-up screen. This format provides a faster access format with reduced chances for misdirection of a flag and is intended for the expert or advanced user. In this mode, if the user decides that a new category of issue box should be reactivated or created, a command can be given (i.e., such as a right click on the mouse, a pull down menu, etc.) to initiate the reactivation prompts described above.

Another important tool is the “Instant Work Product™” tool. This tool creates new or original documents using information from other portions of the program. For example, in a patent litigation application, a draft complaint may be automatically generated once the task profiler function has been completed with the complaint being generated from the information contained in the litigation outline and contact database. The caption for the complaint draws on information in the contact database, while the body of the complaint draws on information from the outline. If the outline (based on answers from the user in the task profiler) indicates that there is a contributory infringement cause of action, the complaint will include sections directed toward contributory infringement, i.e., 35 U.S.C. § 271(c). The user may add amplifying paragraphs to the complaint as desired. The “Instant Work Product™” also provides for the generation of other routine litigation documents including, but not limited to, deposition notices, certificates of service, shells for motion pleadings, subpoenas, summary civil action cover sheets and Hague convention papers. In the case of the due diligence embodiment, documents such as due diligence checklists, assignment documents, employee agreements, SEC filings, etc., can be generated in similar fashion.

The program may optionally contain other expert generated documents, such as protective orders, model jury instructions, interrogatories and document requests, which include static sections (such as standard interrogatories and document requests based upon expert input) relevant to any patent action, but will depend more heavily on user input with regard to the specific details of any given case. The standard content of documents prepared using the Instant Work Product™ feature represents a second way, in addition to the information included in the outline, that expert knowledge is present in the program and imparted to the user.

An example of a document that is more heavily dependent on user input is a privilege log, which can be automatically generated using the database-coded field information (i.e., author, recipient, date, Bates number) and the annotations on the documents entered in the workroom. This information can then be exported to such programs as Microsoft Word®, Microsoft Excel® and or/Corel WordPerfect®. As discussed above, the outline may provide a claim which has been or can be broken down element by element. Also, the instant invention provides a patent genealogy (family tree) function. In accordance with this function, information concerning the filing history, related application data and priority data (when applicable) is used to generate a chart text demonstrating the relationship and history of the application. Each application will have its own unique types of documents which can be generated using the document generation tool.

Another important aspect of the invention is the use of the Internet to host the data stored in the workroom. Most of the information in portions of the program other than the workroom (e.g. outline viewer, contact database, fixed database viewer) can be stored locally (e.g. on a disk drive on a notebook personal computer). However, this may not be possible or desired for documents contained in the workroom, which may include images of thousands and often millions of pages of text. This information is preferably hosted on a network server, and more preferably hosted on a internet-based and accessible server, which may be provided by the user or a third party service provider.

The internet-based server embodiment of the invention is especially important in a law firm setting and in particular in the context of litigation tasks. Existing law firm and corporate computer networks are primarily directed toward maintaining word processing and accounting servers which are accessed by many users. Because much, if not all, of this information exists in the form of text files, the bandwidth required to maintain and access this data is relatively narrow. As such, most law firms and companies have not invested in costly broadband computer networking systems since their primary needs are satisfied by the much lower cost of existing, yet often antiquated, systems. When seeking to access imaged documents on such network servers, firms are often confronted with slow transfer rates, malfunctions in the transfer of images and reduced access speed to other areas of the network such as word processing and accounting documents. Transferring large image files can, in the worst case, cause network shutdown and other “crash” scenarios. The cost of recabling and enhancing such networks to handle large image files is typically very high and often cost-prohibitive. Attempts to retrofit the existing system do not include incorporation of imaging software within their standard network configuration, thus failing to address the problem at its core. Another option is to maintain optical image servers on a separate network with a gateway to the existing word processing/accounting network. Again, this tends to result in slower access to documents and/or images and additional steps to access multiple servers. This tends to frustrate the purpose of networking in general.

With the explosion in internet use in law firms and corporations, bandwidth for internet access has been increased through the use of ISDN, T1, DSL and like means of high speed broadband transfers of data for multiple users. Many times, these intemet gateway connections are the fastest connections in the firm/corporation. Thus, having the ability to access images via the internet provides a significant and practical advantage in the context of the present invention. To address the needs of the end user and to capitalize on existing infrastructure while avoiding excessive costs for hardware upgrades, the present invention also provides for the intemet hosting of the information to be accessed and stored (i.e., such as large numbers of documents, depositions, etc., in the context of patent or other complex litigation). Also, by intemet hosting, the database and imaged information can be accessed from anywhere worldwide. This is highly preferable in the age of mobile access and telecommuting. While there have existed means to access a network database, traditional methods force users to use remote access software to a computer which is logged into a network. Thus, to access images, the information would have to be transferred across the local network and then through the phone line used to remotely access the network computer. An already slow transfer on the network is further impeded or completely frustrated by this process. By maintaining the information on an intemet accessible network, information can be readily accessed and the transfer is faster since the information will be stored on large servers and accessed via broadband connections, thereby obviating the aforementioned limitation.

In order to ensure the integrity and security of the intemet-based information, encryption and other security measures can be employed. Such methodologies are readily available from commercial suppliers. The applicability of new technologies will be readily appreciated and understood by those of ordinary skill in the art.

Also, the present invention provides significant improvement over prior art techniques since the use of internet hosting the database information and images obviates the need for technical expertise on the part of the user and network integration barriers are greatly diminished. Transfer across the local network is obviated, thereby reducing the risks commonly associated with large network programs. Also, the cost of internet hosting greatly reduces the cost normally associated with purchasing additional hardware such as network servers, RAM, cable and optical, CD or magnetic storage systems.

Another important aspect of internet hosting is it allows greater access to law firm/corporate clients when desired. Since the internet-hosted database operates in a fashion which is similar to an extranet, a client can have access to the information required while protecting access to the firm/corporation primary network where other sensitive information is stored. In the context of the present invention, the client would be provided with, for example, an access code which allows the client to directly access the allowed database information and images through the internet. Once again, this increases the transfer rate since a local network with insufficient cabling and processor speed is not being accessed.

Another benefit of the intemet-based aspect of the present invention, is the ability to provide updates and upgrades to expert task materials and/or support information. For example, in the context of patent litigation, newly-issued decisions from the Federal Circuit would be digested and then used to update the reference database files. An end user would receive updates of such case law digests each time they logged into the host server. Similarly, changes in the statutory law would be incorporated such that an authorized login to the internet-hosted server would result in updates to the fixed database files. Similar upgrades to the program files, codes, etc. can be implemented automatically when the authorized user logs into the internet-hosted server.

Another novel aspect of the invention is the “notebook” module which provides a means of organizing the information collected within the outline format for presentation or other formatting. While the notebook functionality may be applied to any number of applications, it is particularly beneficial within the context of the litigation applications. For purposes of explanation, the notebook function will be discussed in the context of the “trial notebook feature.” However, this is purely for example and should not be construed as limiting the invention to this preferred embodiment.

The trial notebook module both provides full functionality for electronic presentation of materials in the courtroom, as well as expert input concerning the organization and structure of the information and data items to be employed at trial. In accordance with the instant invention, the trial notebook module addresses the problems associated with the currently available software and methodologies, allowing for the seamless transfer of electronic data from the litigation support modules of the invention to the courtroom presentation functionality. This allows the user to avoid the costs incurred with currently available systems which require re-imaging the labeled trial exhibits. In a preferred embodiment, the invention may also provide for flexible and customizable functionality which may include the ability to import electronic data directly from sources other than the litigation outline module, including recordable media such as CD-ROM, zip drive, Jaz drive, disk, etc.

The trial notebook module is designed to be used either with, or independent of, the other modules, components and/or tools of the invention. As such, the trial notebook module can be employed even in instances where the litigation outline functions (i.e., the expert-generated task functions) have not been employed previously. In a preferred embodiment, however, the trial notebook module is used in conjunction With the litigation outline and other modules with the information contained in the litigation outline being imported directly into the trial notebook module. Once imported, the issues present in the litigation outline may be reorganized for use in the context of a civil or criminal trial.

Regardless of source, the imported data items and issues are sorted using an expert task management query system similar to that described above. The expert query, as described above, is keyed to the field to which the specific application is drawn. Specifically, the user is prompted with questions which can be general and/or specific in nature. An example of a general litigation question employed within the trial notebook query functionality is: “Please identify each witness (or potential witness) you intend to call in your affirmative case, providing full name and address.” Once a witness' name is entered the user is asked if there are any other witnesses. This routine can proceed ad infinitum until the user indicates that there are no additional witnesses. With the witness list now created, a pop-up screen, similar to that discussed in conjunction with the data item sorting/issue assignment function described above, is provided which contains a checkbox corresponding to each active issue remaining in the litigation outline. If the information is imported de novo from a source other than the litigation outline module, the pop-up screen may contain every issue which is contained in the original expert outline. By checking an issue box in conjunction with a given witness, each data item associated with that issue is thereby associated with said witness. The pop-up screen may also contain issues other than those contained in the outline as defined by the user.

In addition to general topics such as witness identification, in preferred embodiments, the expert-based queries will be directed to specific issues relevant to the applicable trial scenario. For example, in the context of a patent litigation application, such a query could include questions such as “Is ownership of the patents-in-suit in dispute?” A “Yes” answer would prompt the user to assign an attorney in charge of the issue at trial and create an issue folder for same. It would also create a pop-up box so that appropriate witnesses could be assigned. Alternatively, a “No” answer would prompt additional questions such as “Has a stipulation been entered” ensuring that the user meets the necessary procedural requirements and avoid overlooking a critical issue by inadvertence or negligence.

Additional pop-up screen issues may include any useful/applicable issue such as “motions in limine”, “Cross examination”, “Hearsay” or any other expert or user-defined subject matter. By doing so, items associated with such a topic may be electronically flagged using the linking functionality and organized within its own defined electronic folder.

The expert task manager associated with the trial notebook module is intended to guide a user in organizing the discovery-derived data items into a form best suited for the efficient trial of the case as determined by the expert content contained within the software product.

The trial notebook module may also contain expert-derived documents and forms which are keyed to the issues present in the case at hand. For example, the model jury instructions present in the fixed database files may be pared down to correspond to those issues still active in the case at the close of discovery. In a preferred embodiment, the paring function is performed automatically by the software, paring out those issues which were pared out from the litigation outline. Other fixed database objects, such as the Federal Rules of Evidence, are particularly useful in the context of the trial notebook module.

The trial notebook module is designed to aid the user in not only organizing the materials but in maintaining and manipulating them in an efficient manner. For example, the data items associated with a given witness (attorney notes, draft examination questions, documents, transcripts, etc.) can be printed as a “witness binder.” Of particular benefit, the instant invention is intended to organize the information required in typical pretrial orders in the format required by the court of interest, thereby allowing the entire pretrial order to be generated and printed from the expert task manager organized structure.

As noted above, the “notebook” functionality can be employed for any given expert task. For example, in the context of a due diligence product, the notebook fimction can be employed to create an electronic “due diligence notebook” whereby information which has been collected and organized within the expert outline module can be formatted and output to suit any particular circumstance or need. For example, if the due diligence was performed in the context of obtaining financing from one of multiple potential finding sources, the notebook functionality can be employed to organize the due diligence package to meet the format requirements of each given funding source. Another example is where the information collected is to be used for different purposes (i.e., a merger and an offering). The notebook functionality allows the user to “package” the information to suit the particular needs encountered. Of course, modifications to the forgoing examples are contemplated by the inventors, such modifications being recognized and within the skill of those of ordinary skill in the art.

Once in the trial notebook module, the user may be provided a great deal of functionality. Data items may be stored and organized by issue, witness or other expert and/or user-defined criteria. Images, video, animation and other types of electronic data can be retrieved and viewed in the trial presentation window. The trial presentation view allows the user a great deal of functionality through the use of mark-up and annotation tools on toolbars. Such annotations will include at least highlighting, redacting, drawing lines, circles, arrows, rectangles, ellipses and freehand in numerous colors, rotating images, and reducing and enlarging images or portions thereof. The user will also be able to pull multiple images up in different areas of the screen for viewing of multiple pages of a document. The user can also pull out part of the text from the document and enlarge it, leaving the remainder of the document in the background. The user can also gray out portions of the document to accent various parts for review. Annotations to the image or electronic file can be saved and retrieved later.

As described above, an additional feature will be the ability to view multimedia files, such as digitized video depositions transcripts or animations in the image viewer. In a preferred embodiment, such video files are synchronized with audio and text files so the user can listen to and view the digitized deposition while simultaneously viewing the text of the transcript as it scrolls. This functionality is embodied by such available programs as inData Corporation's DepoDirector™ product. Smaller clips or segments may be created and edited from these files to create short outtakes from the deposition to be viewed individually for such purposes as impeachment, cross-examination, etc.

In a preferred embodiment, the user will also have the ability to electronically affix exhibit “stickers” on the image files to create acceptable and required exhibits for purposes of trial. The trial notebook may also include the ability to generate and electronically affix barcodes which may be used as a means of retrieving images or electronic files for presentation. The user will swipe a barked reader over an assigned barked. This prompts the trial presentation viewer to retrieve the associated electronic file for presentation. The presentation system will also allow the user to use a light pen directly on the monitor screen to manipulate the displayed image (zoom, highlight, circle, annotate, etc.) in a manner similar to that employed when one uses a mouse with a personal computer drawing program.

### PATENT LITIGATION PREFERRED EMBODIMENT

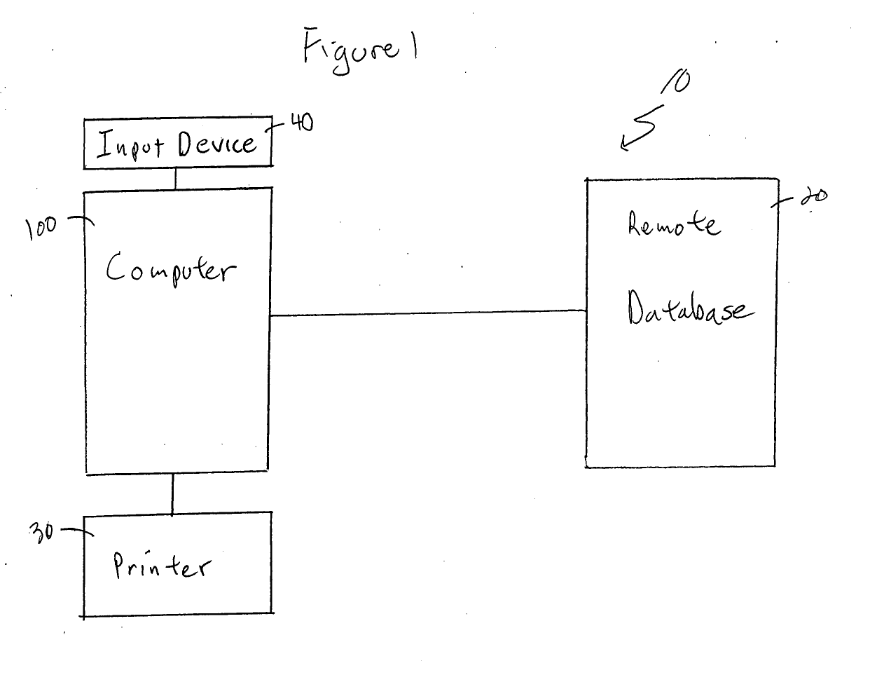

Referring now to the drawings, wherein like reference numerals designate identical or corresponding parts throughout the several views, FIG. 1 shows a hardware block diagram of a patent litigation task management system 10 according to a preferred embodiment of the present invention. The system 10 includes a computer 100 connected to a remote database 20, a printer 30, and an input device 40 such as a scanner with which documents can be imaged. The connection between the computer 100 and the remote database 20 can be implemented over any communication medium/technology. Similarly, the connection between the computer 100 and the printer 30 can be through any communication medium/technology. In preferred embodiments, the computer 100 is a personal computer running a Windows® Linux®, or other operating system, the printer 30 is a laser printer directly connected to the computer 100 or connected to the computer 100 through a local area network, and the remote database 20 comprises a web server connected to one or more mass storage devices such as optical jukeboxes and/or RAID arrays, with the web server itself connected to the computer 100 through an internet connection which may include the public switched telephone network or the medieval technology. It is important to note, however, that many variations on the preferred embodiment are contemplated. For example, while the remote database is hosted on a web server in the preferred embodiment, it will be recognized by those of skill in the art that the remote database may also be hosted on mass storage devices connected to the computer 100 via a LAN or WAN in an office environment.

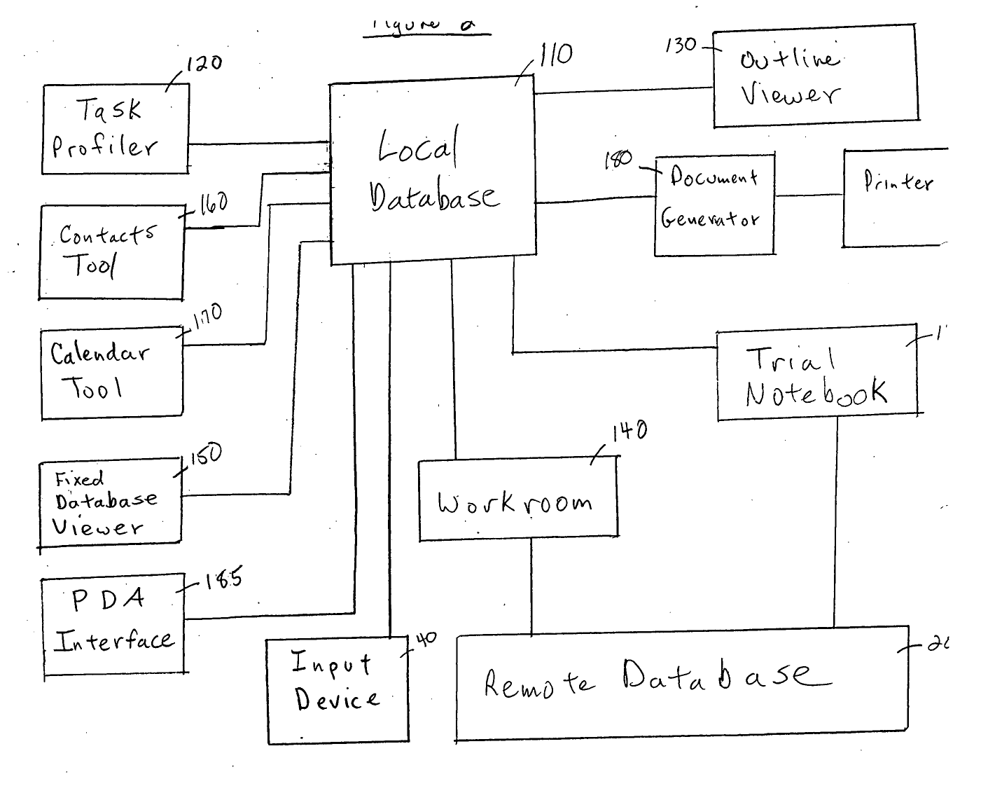

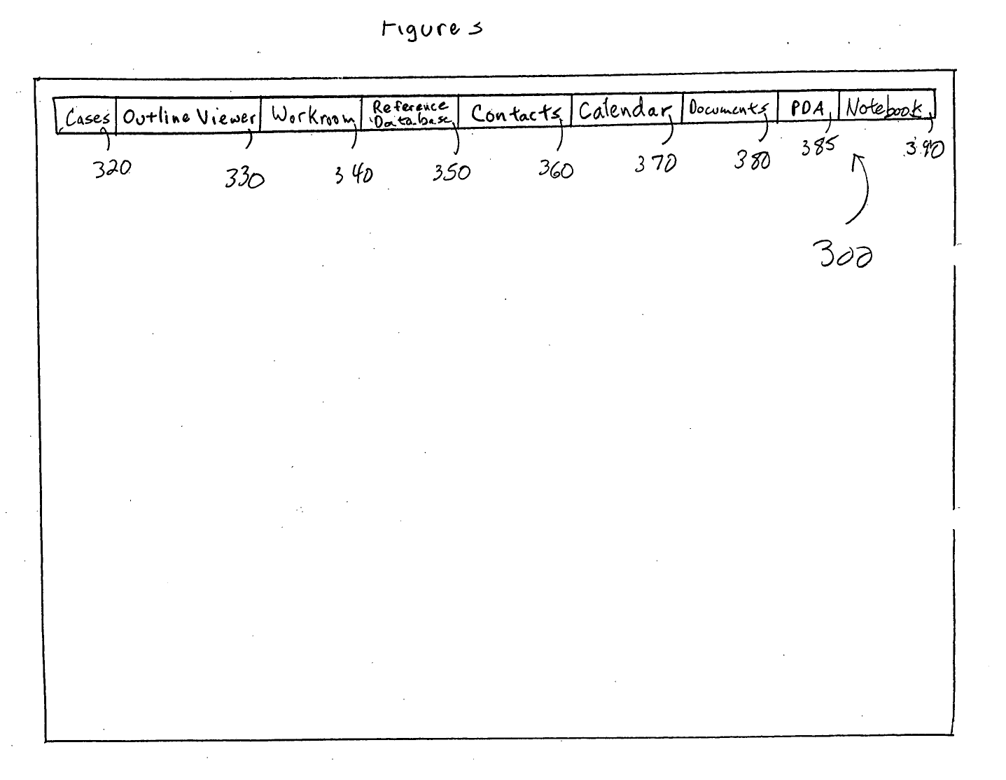

The logical components of the task management system 10 are shown in FIG. 2. These components include the local database 110, the task profiler 120, the outline viewer 130, the workroom 140, the fixed database viewer 150, the contacts tool 160, the calendar tool 170, the Instant Work Product™ tool 180, the PDA interface 185, and the trial notebook 190. Each of these components (with the exception of the local database 110) are accessible through a main menu bar 300, as shown in FIG. 3, which displayed on the monitor of the computer 100 when the patent litigation task manager program is started. A user simply selects one of the menu choices 320-390 to obtain access to the desired component. A detailed explanation of each component is presented below.

A task outline is maintained in the local database 110. The task outline lists all of the possible issues that might arise in a task. The outline is prepared based on expert input and, unlike previous systems, is prepared in advance such that all potential issues are identified. In the patent litigation system 100, these issues are preferably primarily organized according to sections of Title 35 of the United States Code with additional issues relating to common law and other authority as identified by the expert. The contents of a portion of an outline according to a preferred embodiment of the present invention is set forth in Table 1 below:

TABLE 1

```
VALIDITY
  I §101 Subject Matter
        1 Statute/Rule
        2 Interpretation
        3 Case Law Digest
        4 Evidence
        5 Work Product
        6 To do list
  II §102 Anticipation
    A 102(a)
        1 Statute/Rule
        2 Interpretation
        3 Case Law Digest
        4 Evidence
        5 Work Product
        6 To do list
    B 102(b)
        1 Statute/Rule
        2 Interpretation
        3 Case Law Digest
        4 Evidence
        5 Work Product
        6 To do list
    C 102(c)
        1 Statute/Rule
        2 Interpretation
        3 Case Law Digest
        4 Evidence
        5 Work Product
        6 To do list
    D 102(d)
        1 Statute/Rule
        2 Interpretation
        3 Case Law Digest
        4 Evidence
        5 Work Product
        6 To do list
    E 102(e)
        1 Statute/Rule
        2 Interpretation
        3 Case Law Digest
        4 Evidence
        5 Work Product
        6 To do list
    F 102(f)
        1 Statute/Rule
        2 Interpretation
        3 Case Law Digest
        4 Evidence
        5 Work Product
        6 To do list
    G 102(g)
        1 Statute/Rule
        2 Interpretation
        3 Case Law Digest
        4 Evidence
        5 Work Product
        6 To do list
  III §103 Obviousness
        1 Statute/Rule
        2 Interpretation
        3 Case Law Digest
        4 Evidence
        5 Work Product
        6 To do list
  IV §112 First Paragraph
    A Enablement
        1 Statute/Rule
        2 Interpretation
        3 Case Law Digest
        4 Evidence
        5 Work Product
        6 To do list
    B Written Description
        1 Statute/Rule
        2 Interpretation
        3 Case Law Digest
        4 Evidence
        5 Work Product
        6 To do list
    C Best Mode
        1 Statute/Rule
        2 Interpretation
        3 Case Law Digest
        4 Evidence
        5 Work Product
        6 To do list
  V §112 Second Paragraph
        1 Statute/Rule
        2 Interpretation
        3 Case Law Digest
        4 Evidence
        5 Work Product
        6 To do list
  VI §116 Inventorship
        1 Statute/Rule
        2 Interpretation
        3 Case Law Digest
        4 Evidence
        5 Work Product
        6 To do list
INFRINGEMENT
  VII §271 Infringement
    A Direct Infringement §271(a)
        1 Statute/Rule
        2 Interpretation
        3 Case Law Digest
        4 Evidence
        5 Work Product
        6 To do list
    B Inducement to Infringe §271(b)
        1 Statute/Rule
        2 Interpretation
        3 Case Law Digest
        4 Evidence
        5 Work Product
        6 To do list
    C Contributory Infringement §271(c)
        1 Statute/Rule
        2 Interpretation
        3 Case Law Digest
        4 Evidence
        5 Work Product
        6 To do list
    D Literal infringement vs. infringement under the doctrine of
      equivalents
        1 Statute/Rule
        2 Interpretation
        3 Case Law Digest
        4 Evidence
        5 Work Product
        6 To do list
  VIII Inequitable Conduct/Fraud on the Patent Office
        1 Statute/Rule
        2 Interpretation
        3 Case Law Digest
        4 Evidence
        5 Work Product
        6 To do list
  IX Patent Misuse
        1 Statute/Rule
        2 Interpretation
        3 Case Law Digest
        4 Evidence
        5 Work Product
        6 To do list
  X Common Law Defenses
    A Laches
        1 Statute/Rule
        2 Interpretation
        3 Case Law Digest
        4 Evidence
        5 Work Product
        6 To do list
    B Equitable Estoppel
        1 Statute/Rule
        2 Interpretation
        3 Case Law Digest
        4 Evidence
        5 Work Product
        6 To do list
    C Prosecution History Estoppel
        1 Statute/Rule
        2 Interpretation
        3 Case Law Digest
        4 Evidence
        5 Work Product
        6 To do list
```

For each of the lowest level items, the outline contains six subsections: 1) the corresponding patent statute or common law statement of the rule; 2) interpretation; 3) case law digest; 4) evidence; 5) work product; and 6) to do list. Subsection 1, the corresponding patent statute or common law statement of the rule, contains the statute or rule for review by the user. For example, for outline item IV(B)(1), the following is listed: “35 U.S.C. § 112: ‘the specification . . . shall set forth the best mode contemplated by the inventor of carrying out his invention.’”

Subsection 2 provides an expert provided interpretation of the statute or common law rule. For example, item IV(B)(2), Best Mode, may contain a description such as:

The purpose of the “best mode requirement” is to restrain inventors from applying for patents while at the same time concealing from the public preferred embodiments of their invention. In re Gay, 309 F.2d 769, 772 (C.C.P.A. 1962). The best mode requirement is distinct from the enablement requirement. “Compliance with the best mode requirement focuses on a different matter than does compliance with the enablement requirement. Enablement looks to placing the subject matter of the claims generally in the possession of the public. If, however, the applicant develops specific instrumentalities or techniques which are recognized at the time of filing as the best way of carrying out the invention, then the best mode requirement imposes an obligation to disclose that information to the public as well. Spectra-Physics, Inc. v. Coherent, Inc., 827 F.2d 1524 (Fed. Cir. 1987).

Subsection 3 provides case law digests on various issues concerning the lowest level item. The identification of the issues and the case law digests are provided by the expert. Item IV(B)(3) contains a case law digest such as:

Legal standards:

Whether or not an inventor has complied with the best mode requirement is a question of fact, Scripps Clinic & Research Foundation v. Genentech, Inc., 927 F.2d 1565, 1578 (Fed. Cir. 1991), and failure to comply with this requirement must be shown by clear and convincing evidence. U.S. Gypsum Co. v. National Gypsum Co., 74 F.3d 1209, 1212 (Fed. Cir. 1996); Minco, Inc. v. Combustion Engineering, Inc., 95 F.3d 1109, 1115 (Fed. Cir. 1996).

The test for compliance with the best mode requirement:

A best mode analysis involves two underlying factual inquiries. First, it must be determined whether, at the time the patent application was filed, the inventor had a best mode of practicing the claimed invention. This inquiry is wholly subjective. Second, if the inventor had a best mode of practicing the claimed invention, it must be determined whether the specification adequately disclosed what the inventor contemplated as the best mode so that those having ordinary skill in the art could practice it. The latter question is largely an objective inquiry that depends upon the scope of the claimed invention and the level of skill in the art. U.S. Gypsum, 74 F.3d at 1212; Great Northern Corp. v. Henry Molded Products, Inc., 94 F.3d 1569, 1571 (Fed. Cir. 1996).

Adequacy of the Disclosure:

With regard to the adequacy of disclosure, the Federal Circuit has held that if the disclosure of an inventor's best mode is so objectively inadequate as to effectively conceal the best mode from the public, the best mode requirement has not been satisfied. U.S. Gypsum, 74 F.3d at 1215; Transco, 38 F.3d at 560 (“Even where there is a general reference to the best mode of practicing the claimed invention, the quality of the disclosure may be so poor as to effectively conceal it.”).

The relevance of the inventor's state of mind:

An inquiry into whether or not the best mode requirement has been complied with focuses on the state of mind of the inventor at the time the inventor files the patent application. Minco, 95 F.3d at 1115; Glaxo Inc. v. Novopharm Ltd., 52 F.3d 1043, 1050 (Fed. Cir. 1995). Accordingly, the inventor's intent generally controls. Glaxo, 52 F.3d at 1050; Minco, 95 F.3d at 1115 (“To invalidate a patent under the best mode requirement, an accused infringer must show by clear and convincing evidence that the inventor ‘both knew of and concealed a better mode of carrying out the claimed invention than was set forth in the specification.’” (quoting Transco Prods. Inc. v. Performance Contracting, Inc., 38 F.3d 551, 560 (Fed. Cir. 1994))).

A best mode violation DOES NOT require an intent to conceal the best mode:

Violation of the best mode requirement may occur whether the inventor's concealment is “accidental” or “intentional.” U.S. Gypsum, 74 F.3d at 1215-12-16. Thus, if the inventor appreciates a best mode for carrying out the invention, invalidity of the patent may result from the inventor's failure to disclose such mode, regardless of whether the inventor specifically intended to conceal his or her best mode. U.S. Gypsum, 74 F.3d 1216 (“Inquiry into an intent to conceal, being subjective, is inconsistent with the objective nature of the second aspect of best mode compliance. It is not part of that analysis.”); see Minco, 95 F.3d at 1116.

Subsection 4 contains user-derived evidence/information related to the actual issue presented in the case at hand. This subsection will be empty upon the start of the task management process. As explained in further detail below, the user will place evidence into this subsection as the evidence is identified.

Subsection 5 contains user-derived work product. This subsection will also be empty upon the start of the program and the user will place work product into this subsection as such work product is generated.

Subsection 6 is designed to contain a user-defined collection of action items for the corresponding issue. It is contemplated that the user will employ this section to collect thoughts and concepts which may not be associated with an individual piece of evidence, and hence not placed on a “sticky note,” or which may be otherwise useful. The user may employ this section to place reminders about tasks that need to be accomplished, such as “remember to ask inventor Smith about the widget sold by Acme on Jan. 1, 1999 as this may be the best mode contemplated by the inventor.” In a preferred embodiment, these action items can be automatically appended to other folders and docket items by using a user-defined qualifier. Such action will place an electronic flag within any folder containing that qualifier such as “Deposition File for Inventor Smith” as well as creating a reminder prompt associated with the scheduling of the Smith Deposition within the calendar fimction.

As discussed above, the outline represents the starting point for the task management process. The user interacts with the outline to manage the task by eliminating irrelevant sections, associating documents and information with the outline, and preparing documents using the outline. The manner in which this interaction occurs is described below.

Upon startup, several menu items are available to the user. Many are available in their original expert format before the user has input any case specific information. Examples of such menu items include items 320, 330, 350, 360, and 370. In a preferred embodiment the remaining menu items 340, 380 and 390 are grayed out and are not selectable until a case has been created or selected using the Cases menu (item 320).

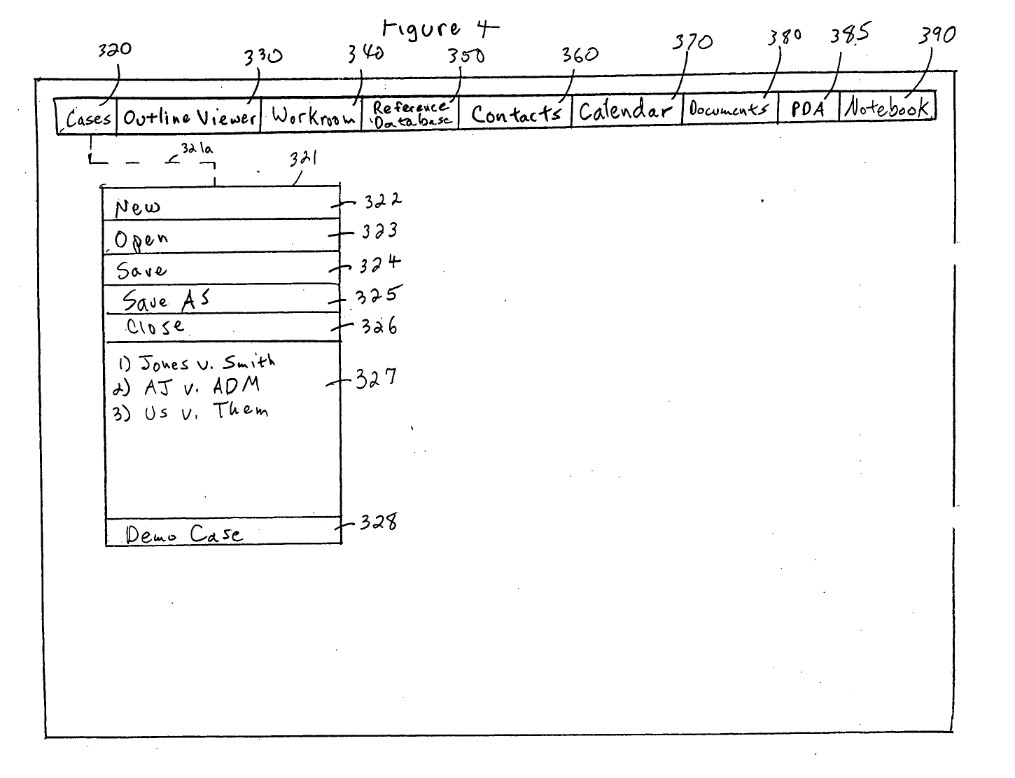

Selecting the Cases menu, item 320, results in a pull-down window 321 such as that. shown in FIG. 4. (The dashed line 321a is not visible to the user; it is shown in FIG. 4 solely to illustrate the logical relationship between the Cases menu item 320 and the Cases pull-down window 321.) The Case menu pull-down window 321 allows a user to specify which case she wishes to work on. The system 100 provides for multiple cases and keeps them logically separated and accessible to only those individuals having approved access. Such security measures are commonly employed within the art and it is contemplated that the subject invention can be modified to accommodate the particular security needs of a given application without altering the basic nature of the invention.

There are several ways in which a user can select a case. The user may select the open case button 323, at which point the user will be presented with a text entry window in which the user may type the name of the case. Alternatively, the user may select one of these cases by simply clicking on the name of the case in the recently accessed case field 327, which lists the names of the cases most recently accessed.

If it is necessary to start a new case, the user may select the new button 322. The new button 322 invokes the case profiler function, as will be discussed in further detail below. After the user has finished a session, any changes made to the local database can be saved by selecting the save menu item 324. The system 100 also provides the option of saving changes under a new case name through the save as button 325. This option is expected to be rarely used. Finally, a demo case button 328 may be invoked by a user. This option provides the user with the ability to call up a fictitious case, which allows the user to see, for example, how an outline has been pared and evidence has been associated with the various outline sections, etc.

As discussed above, selecting the new menu button 322 invokes the task profiler module 120. The task profiler module 120 will display a pop-up window in which a number of questions about the case will be presented to the user. In preferred embodiments, the user will be asked for logistical/procedural information such as:

1. Case Caption

2. Client Matter Number

3. Lead Counsel

4. Second Chair Counsel

5. Third Chair Counsel

6. Firm Name, Address, Telephone & Fax

7. Local Counsel

8. Firm Name, Address, Telephone & Fax

9. Co-counsel (if any)

10. Firm Name, Address, Telephone & Fax

11. (Repeat 9 as required)

12. Venue

1. District

2. Division

3. District Judge

i. Telephone

ii. Fax

iii. Law Clerk

iv. Secretary

4. Magistrate Judge (if assigned)

i. Telephone

ii. Fax

iii. Law Clerk

iv. Secretary

5. Civil Action Number

12. Client Information

1. Client Name

2. Client Address

3. Telephone Number

4. Fax Number

5. Primary Contact

i. Direct Dial Phone Number

ii. Other Information

6. In-House Counsel

7. State of Incorporation

8. Principle Place of Business

13. Co-Parties Information (if any)

1. Party Name

2. Party Address

3. Telephone Number

4. Fax Number

5. Primary Contact

i. Direct Dial Phone Number

ii. Other Information

6. In-House Counsel

7. State of Incorporation

8. Principle Place of Business

14. (Repeat 13 as required)

15. Opposing Party Number 1

1. Client Name

2. Client Address

3. Telephone Number

4. Fax Number

5. State of Incorporation

6. Principle Place of Business

16 Opposing Party Number 2

1. Client Name

2. Client Address

3. Telephone Number

4. Fax Number

5. State of Incorporation

6. Principle Place of Business

17. (Repeat 16 as required)

18. Lead Counsel for Opposing Party

19. Second Chair Counsel for Opposing Party

20. Third Chair Counsel for Opposing Party

21. Firm Name, Address, Telephone & Fax

22. Local Counsel for Opposing Party

23. Firm Name, Address, Telephone & Fax

24. Co-counsel for Opposing Party (if any)

1. Firm Name, Address, Telephone & Fax

25 (Repeat 9 as required)

The task profiler 120 then asks whether the user is the plaintiff or the defendant. This information, which is stored in the local database, is used by the system in a number of ways. One way it is used is to determine which questions are asked of the user. Although the outline will be the same regardless of whether the user is the plaintiff or defendant, the questions asked will differ.

26. Are you the plaintiff?

1. If no, then assign as defendant

2. If yes, then ask if affirmative plaintiff

i. If no, ask if declaratory judgment plaintiff (go to 27)

ii. If yes, then assign client as plaintiff (go to 28)

The following question is asked only if the user is a declaratory judgment plaintiff:

27. Questions concerning Declaratory Judgment

1. Basis for case or controversy [hot key to Title 28 §]

2. Subject matter jurisdiction (insert paragraph re: 28 U.S.C. § 2201)[hot key to Title 28 §]

3. Insert standard paragraph re: SMJ [hot key to Title 28 §]

4. Ask if any other SMJ basis [hot key to Title 28 §]

5. Go to 29

The following question is asked if the user is a plaintiff:

28. Subject matter jurisdiction

b 1. Insert standard paragraph re: SMJ [hot key to Title 28 §]

2. Ask if any other SMJ basis [hot key to Title 28 §]

3. Go to 29

All users are asked the following questions concerning the patents at issue:

29. Patent(s)-in-suit

1. Patent #1

i. Patent No.

ii. Assignee

iii. First Inventor

iv. Additional Inventors (if any)

v. Title of Invention (convert to ALL CAPS)

vi. Number of claims

(1) Number of independent claims

(a) Identify claim numbers

(2) Number of dependent claims

2. Are there additional patents?

i. If no, go to 30

ii. If yes, go to 29(c)

3. Patent #2 (if any)

i. Patent No.

ii. Assignee

iii. First Inventor

iv. Additional Inventors (if any)

v. Title of Invention (convert to ALL CAPS)

vi. Number of claims

(1) Number of independent claims

(a) Identify claim numbers

(2) Number of dependent claims

4. Are there additional patents?

i. If no, go to 30

ii. If yes, go to 29(e)

5. Repeat 29(c) & (d) as required

The following questions are asked for the purpose of preparing a complaint:

30. Allegation of infringement

31. Request for Relief

1. Put in a checklist of possible relief available

i. Permanent injunction (35 USC § 283)[hot key to Title 35 §]

ii. Preliminary injunction (35 USC § 283)[hot key to Title 35 §]

iii. Damages for past infringement (35 USC § 284)[hot key to Title 35 §]

iv. Increased damages for willful infringement (35 USC § 285)[hot key to Title 35 §]

v. Attorney fees (35 USC § 285)[hot key to Title 35 §]

vi. Costs (Fed.R.Civ.P. 54(d))[hot key to FRCP §]

vii. Declaration of invalidity of patents in suit

viii. Declaration of unenforceability of patents in suit

ix. Declaration of non-infringement of patents in suit

x. Punitive damages

xi. Any other relief the Court may deem appropriate under the circumstances

xii. Other (request input)

This information is maintained in the local database 110 for and used by the other modules such as the contacts tool 160 and the Instant Work Product™ tool 180 for the purposes of generating a contact database, generation of pleadings, and other uses as described in greater detail below.

After such basic information has been entered, the task profiler 120 will then ask a series of questions for the purposes of identifying and deactivating the issues in the outline that are not relevant to the task at hand. Each outline subtask may have one or more questions associated with it. For example, in a patent litigation context, the user may preferably be asked the following questions:

1. What was the best mode known for practicing the claimed invention?

2. What is the basis for this assertion?

3. Is there evidence that the inventor(s) knew of the alleged best mode?

4. What is the basis for this assertion?

5. Did the inventor(s) know of the best mode prior to the original filing date of the patent application?

6. Does the specification adequately disclose what the inventor contemplated as the best mode so that those having ordinary skill in the art could practice it?

7. Is the best mode discernable from the disclosure even if not explicitly recited?If yes, there may still be a best mode violation. Compare, Wang Laboratories, Inc. v. Mitsubishi Electronics America, Inc., 103 F.3d 1571 (Fed. Cir. 1997)(Upholding district court finding of no best mode violation where one skilled in the art would discern this best mode from the disclosure) with Dana Corp. v. IPC Limited Partnership, 860 F.2d 415 (Fed.Cir. 1988)(Best mode violation found even thought the withheld best mode treatment was disclosed and known in the prior art). Do you wish to consider this possible defense?

8. What evidence is available that the inventors.knew of a better mode for practicing their invention than that disclosed in the patent application?

9. Is there evidence that the concealment of the best mode was intentional? (A violation of the best mode requirement may occur whether the inventor's concealment is “accidental” or “intentional.” U.S. Gypsum, 74 F.3d at 1215-12-16. Thus, if the inventor appreciates a best mode for carrying out the invention, invalidity of the patent may result from the inventor's failure to disclose such mode, regardless of whether the inventor specifically intended to conceal his or her best mode. U.S. Gypsum, 74 F.3d 1216 (“Inquiry into an intent to conceal, being subjective, is inconsistent with the objective nature of the second aspect of best mode compliance. It is not part of that analysis.”); See Minco, 95 F.3d at 1116.)

The answers to some of the questions are stored into the work product section of the outline. For example, the answers to the first five questions of the best mode issue are stored in the work product section of the outline. If question six is answered in the affirmative, the entire best mode portion of the outline is deactivated. The answers to the remaining best mode questions are stored in the work product section of the outline.

Once the task profile has completed, access to all menu items 330-390 is allowed. If the user selects the outline viewer, the outline will be presented to the user in its current form. The user will be allowed to choose to view the outline at any desired level and will have the option of viewing the outline with only active sections displayed or with inactive sections displayed in a grayed-out or shadowed fashion. The user will be allowed to manually deactivate sections of the outline or manually reactivate inactive sections of the outline.

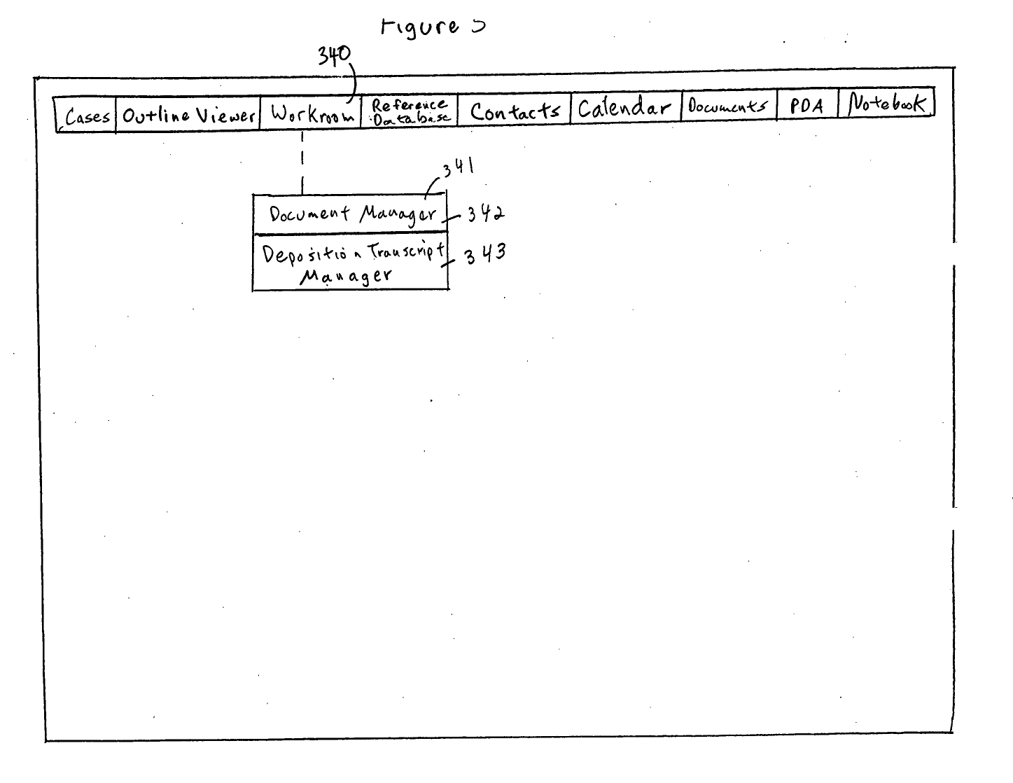

The user will select the workroom menu item 340 to invoke the workroom module 140. Upon selecting the workroom item 340, the workroom menu 341 is displayed as in FIG. 5. The workroom menu 341 includes two buttons: the document manager button 342 and the deposition transcript manager button 343. The document manager and deposition transcript manager allow documents and transcripts to be reviewed, annotated, classified, and associated with sections of the outline.

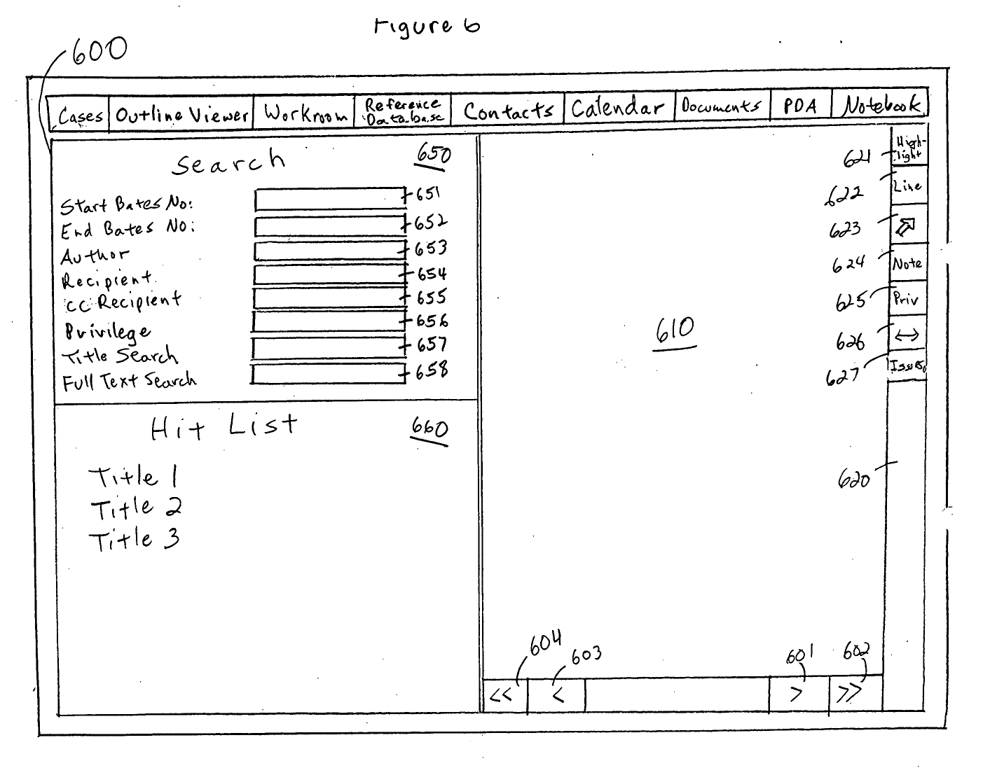

The document manager window 600 is shown in FIG. 6. The document management window 600 includes a document viewer area 610 in which a page of a document can be displayed. The documents being viewed are stored in the remote database 20 or can be inputted through the input device 40, as necessary. The user may move forward a page at a time by clicking on the next page button 601 or may move forward to the next document by pressing the next document button 602. A previous page button 603 and previous document button 604 are also provided. A toolbar 620 includes a number of tool buttons 621-627. The highlight button 621 allows the user to highlight portions of the document being viewed. The line button 622 allows the user to draw a line on the document. The arrow button 623 allows an arrow to be drawn on the document to point to something of interest in the document. The note button 624 allows the user to write a note that is kept with the document. The privilege button 625 allows the user to make a document as privileged. The expand button 626 causes a window to pop up next to the document viewer area 610. This pop up window contains the optical character recognition text associated with the document image. The user can then copy the OCR text for use in other documents such as a memorandum of law. The outline button 627 is the primary means provided for associating a document to the outline.

When the issue button 627 is pressed, an issue window 700 pops up. The issue window 700 contains check boxes for all issues currently active in the outline that are at levels above the evidence level as shown in Table 1. (Alternatively, the issue window may display both active and inactive outline sections (i.e., every issue contained in the complete expert outline). In this case, the user may be required to right-click—rather than left click—to check the box, which will also have the effect of reactivating the corresponding outline section.) The user simply checks the box or boxes to which the document is applicable. For example, if the document being reviewed is a license agreement concerning the patent at issue and the license agreement requires royalties to be paid for both patented and unpatented products, the document can be associated with the patent misuse issue by checking the patent misuse box 701.

After the desired boxes have been checked by the user, the user presses the OK button 702. In preferred embodiments of the invention, the documents, transcripts, deposition videos and other materials are stored in the remote database 20. Pressing the OK button 702 causes a copy of the document to be downloaded from the remote database 20 to the local database 110 and a link to be formed between the appropriate evidence section of the outline (e.g. section VIII(4), Patent Misuse—Evidence) and the document. Any notes, highlighting, etc. are maintained during this operation.

Referring back now to FIG. 6, the upper left hand portion of the document manager window is the search window 650. The search window includes a number of search fields by which the documents can be searched. The user types the desired parameter into one or more of the desired search field, which include the following fields: start bates number 651, end bates number 652, author 653, recipient 654, cc recipient 655, privilege 656, title search 657, and full text search 658. The first five fields 651-655 are self explanatory. The privilege field is used to search only through the documents marked as privileged by a user with the privilege button 625. If a user wishes to search for documents having a word or phrase in the title, the search query is entered into field 657. A search of the full text of all documents will be performed for a search query entered into field 658. Preferably, a full range of search queries, including single words (balloon), phrases (“water balloon”), boolean expressions (“water balloon” & break), proximity searches (“water balloon” within/7 break), etc., similar to the search capabilities found in commercial programs such as Lexis® and Westlaw®, are provided. The search function will combine fields such that it is possible, for example, to run a search for documents authored by John Smith that were sent to Tom Jones and that reference the “Korean contract” in their title.

The results of a search are displayed, by document title, in the hit list window 660. A user can view any document by simply clicking on the title. Doing so will cause the selected document to be displayed in the document viewer window 610.

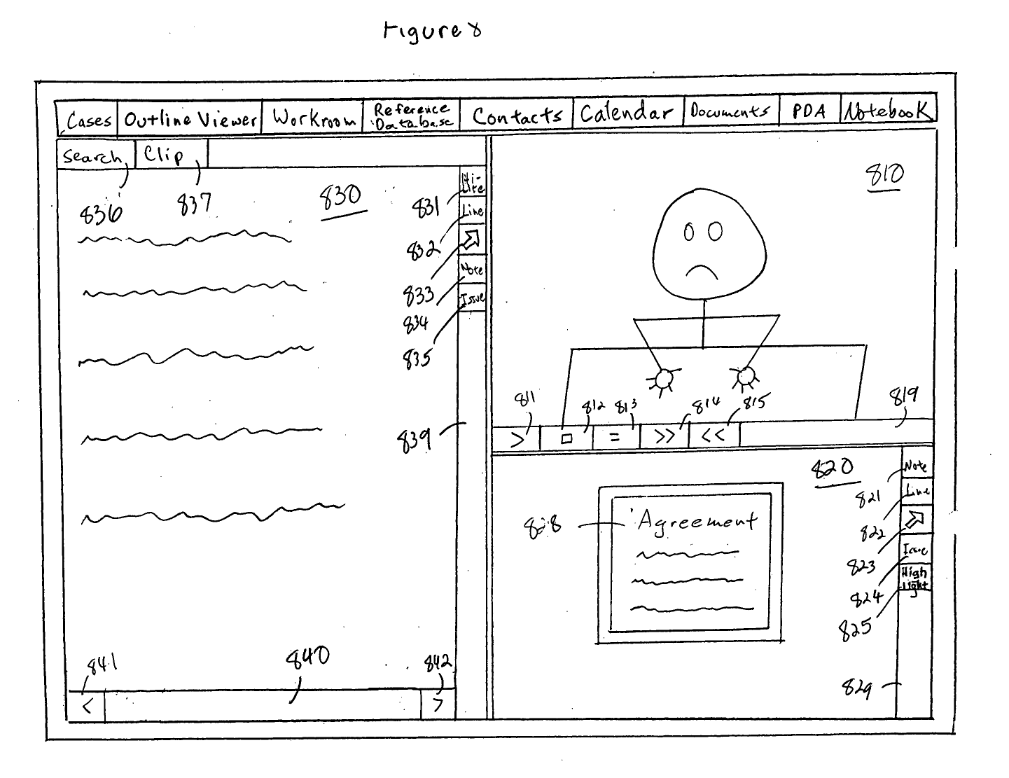

Selecting the deposition transcript manager button 343 from workroom menu 341 (FIG. 5) will cause the deposition transcript manager window 800 to be displayed as shown in FIG. 8. The deposition transcript manager window 800 includes three main sections: the video viewer 810, the exhibit viewer 820, and the transcript viewer 830. In preferred embodiments, depositions will have been taped and transcripts will be synchronized to the deposition vide. The deposition video is displayed in the video viewer window 810. A VCR-like toolbar 819 includes a play button 811, a stop button 812, a pause button 813, a fast forward button 814 and a rewind button 815. Any exhibit that is being discussed during the deposition will be displayed in the exhibit viewer 820. In FIG. 8, the witness is being deposed concerning an illegal patent tying agreement 828. The exhibit viewer includes a toolbar 829 with a note button 821, a line button 822, an arrow button 823 an issue button 824 and a highlight button. The functions of these buttons are the same as the functions of the corresponding buttons in FIG. 6.

A deposition transcript is shown in the transcript viewer 830. A toolbar 839 includes buttons 831-835 similar to those of FIG. 6. Also included is a search button 836, which allows the user to enter a search query such as the queries discussed above in connection with FIG. 6. The clip button 837 allows a video clip to be created by selecting a portion of the transcript text and pressing the clip button 837. This causes the issue pop-up box 700 to be displayed so that the user can associate the video clip with an outline section. The transcript viewer also includes a page toolbar 840 with a page back button 841 and a page forward button 842. It is important to note that the transcript viewer 830 and the video viewer 810 are synchronized such that pressing any of the VCR controls 811-815 causes the transcript viewer to update, while pressing the page backward/forward buttons 841, 842 (or parsing through search results in the transcript) causes the video to update accordingly.

Referring now back to FIG. 3, if the user selects the Reference database menu item 350, a pop up window with a list of available references is displayed. The user may select a desired reference by simply clicking on the reference. In preferred embodiments, the references include Titles 28 and 35 of the United States Code, Chapter 37 of the Code of Federal Regulations, the Manual of Patent Examining Procedure, Black's Law Dictionary, the Federal Rules of Civil Procedure, the Federal Rules of Evidence, the Federal Rules of Appellate Procedure, the Manual of Complex Litigation, and Chisum on Patents as well as user-defined links which may be added.

Selecting the Contacts button 360 will display a listing of all names in the contact database. The user may select any name, in which case all contact information associated with that name will be displayed. A search function for names is also provided.

Selecting the Calendar button 370 will display a calendar that will display all due dates in a number of fashions as is common. The calendar function will have the additional feature of automatically listing dates determined by local court rules.

Selecting the documents button 380 will allow the user to produce any one of a number of documents, preferably including: a complaint, motion papers, a certificate of service, claim charts, a patent genealogy, a deposition notice, a privilege log, a protective order, interrogatories, document requests, requests for admission, a subpoena, a summons, a civil cover sheet, Hague convention-related papers, and model jury instructions. These documents will be prepared using information stored in the local database 110 (and, in the case of the privilege log, privilege annotations to documents'stored in the remote database 20). These documents contain much expert-provided information and represent an important way in which the non-expert user can be guided through the task.

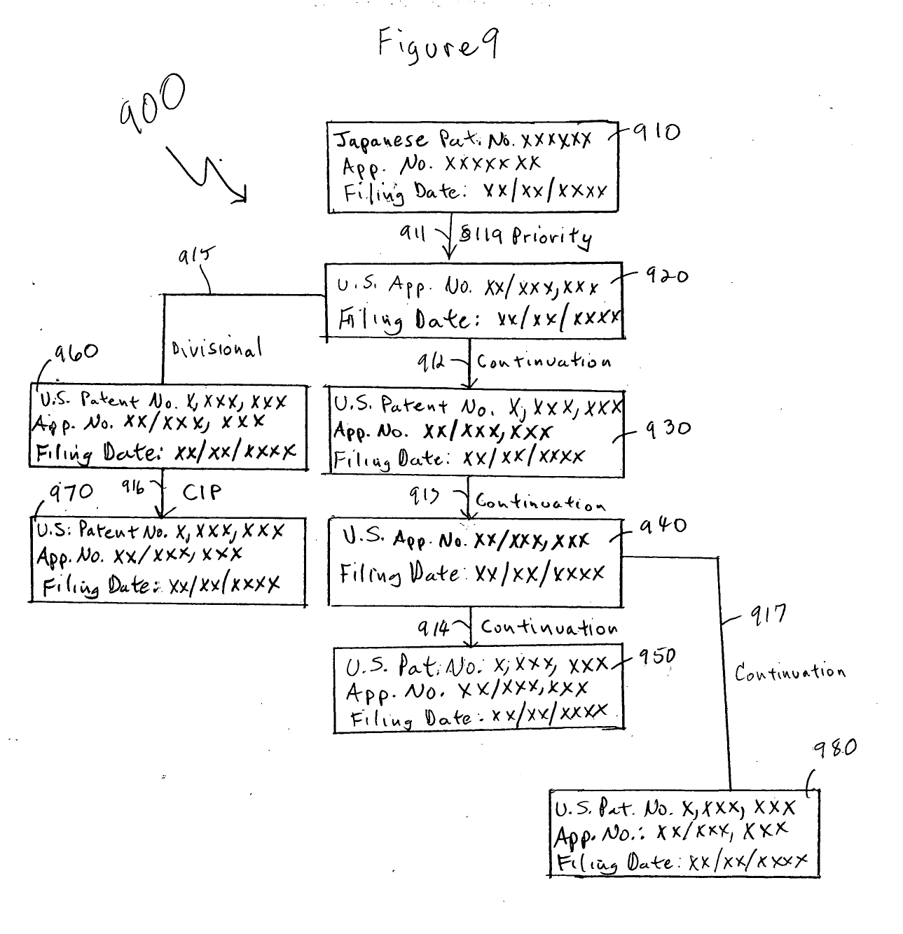

The form of the documents discussed above are all well-known to those of skill in the art with the exception of the patent genealogy. An example of a patent genealogy 900 is shown in FIG. 9. The genealogy 900 starts with a listing 910 for a Japanese patent. The Japanese patent listing 910 has one branch 911 which is connected to a U.S. application number listing 920. The branch 911 indicates that 35 U.S.C. § 119 priority was claimed. There is no patent number associated with listing 920, which indicates that no patent issued on that application. However, branches 912 and 915 indicate that the continuation application referenced in listing 930 and the divisional application referenced in listing 960 claimed priority from the application referenced in listing 920. The genealogy 900 includes several other applications and patents that directly or indirectly claim priority from the applications discussed above as indicated by the various branches 911-917. Although the lowest level items 950, 970, 980 all reference a patent, it is also possible for a lowest level item to reference an application that has not matured into a patent.

The PDA button 385, when activated, starts a synchronization process between a personal digital assistant such as a Palm Pilot® or other device as discussed above and the local database 110. A subset of the information in the local database, such as contacts and the calendar for example, can be downloaded to and viewed on the PDA.

Finally, the user can select the trial notebook button 390. The trial notebook is expected to be used as trial approaches. A second interactive question and answer session, similar to the task profiler 120, will guide the user through the process of preparing witness binders, preparing exhibits, ensuring that evidence exists for all elements of each cause of action or defense being asserted, etc.

Obviously, numerous modifications and variations of the present invention are possible in light of the above teachings. It is therefore to be understood that within the scope of the appended claims, the invention may be practiced otherwise than as specifically described herein.

What is claimed is:

1. A method of managing complex litigation tasks by at least one user, comprising:
(1) providing an informational outline which may be necessary to be complete said tasks;
(2) querying said at least one user as to the relevance of each of said potential elements and receiving responses to said inquiries,
(3) removing from said informational outline those potential elements indicated by said responses to be not relevant, and
(4) generating an informational outline responsive to said task by assembling all said potential elements not removed in step 3.

2. The method of claim 1, which further includes a step of permitting the at least one user to manually remove said potential elements from said informational outline prior to step 1.

3. The method of claim 1, wherein said method further comprises providing said user with the opportunity to view data relevant to each of said potential elements.

4. The method of claim 3, wherein said data is segregated and correlated by association of portions thereof relevant to each said potential element with said potential element.

5. The method of claim 3, wherein said data is selected from the group consisting of document images, optical character recognition versions of document images, deposition transcripts, deposition videotapes and mixtures thereof.

6. The method of claim 1, wherein said method comprises a step of storing data associated with at least one potential element of said task in a local database.

7. The method of claim 3, wherein said method further comprises the steps of associating notes concerning said data entered by a user with the data and storing said notes correlated with said data and said potential elements.

8. The method of claim 1, wherein said complex task is one or more tasks pertinent to a patent infringement litigation.

9. The method of claim 8, wherein said task is the preparation of a complaint for patent infringement.

10. The method of claim 8, wherein said task is the preparation of an answer to a complaint for patent infringement.

11. The method of claim 8, wherein said task is the preparation of a complaint seeking declaratory judgment of at least one of patent invalidity, patent unenforceability or non-infringement.

12. The method of claim 8, wherein said task is the preparation of a counterclaim for patent infringement.

13. The method of claim 8, wherein said task is the preparation of a litigation strategy for a party to a patent litigation.

14. The method of claim 8, wherein said task is the preparation of at least a portion of a pleading, motion or other paper to be filed in a court on behalf of a party to a patent litigation.

15. The method of claim 8, wherein said task is the completion of at least part of a document prepared in connection with said patent litigation which is not to be filed in court.

16. The method of claim 15, wherein said document is a privilege log.

17. The method of claim 1, wherein said user is provided with a reference database which comprises the body of at least one Statute, Rule, Code, advisory text, reference text, constitution or treaty, which can be queried in the course of completion of said complex litigation task.

18. The method of claim 17, wherein said reference database comprises at least one of the group consisting of the Federal Rules of Civil Procedure, Title 28 of the United States Code, Title 35 of the United States Code, Chapter 37 of the Code of Federal Regulations, the Manual of Patent Examining Procedure, Black's Law Dictionary, the Federal Rules of Civil Procedure, the Federal Rules of Evidence, the Federal Rules of Appellate Procedure, the Manual of Complex Litigation, Chisum on Patents and Local Rules of the United States District Courts.

19. The method of claim 3, wherein at least some of said data is maintained on an accessible storage device, selected from the group consisting of the personal computer, a lap-top computer, a networked server and an internet accessible server.

20. The method of claim 1, wherein said steps of providing, inquiring and receiving responses are effected by receiving output from a computing device and said at least one user generating signals rendered intelligible to said computing device responsive to said output and inputting said signals to said computing device.

21. The method of claim 20, wherein said signals intelligible to said computing device are produced by use of at least one of a pointing device, an electronic screen on which information may be portrayed, a keyboard, a microphone and an interface with a second computing device.
